(19) United States
(12) Patent Application Publication
(10) Pub. No.: US 2016/0128282 A1
(43) Pub. Date: May 12, 2016

(54) WATER CATCHING AND DRAINING SAUCER AND COMPLEMENTARY CATCH BASIN

(71) Applicant: Ursula Halferty, Blacksburg, VA (US)

(72) Inventor: Ursula Halferty, Blacksburg, VA (US)

(21) Appl. No.: 14/845,449

(22) Filed: Sep. 4, 2015

Related U.S. Application Data
(60) Provisional application No. 62/078,494, filed on Nov. 12, 2014.

(51) Int. Cl. A01G 9/04

(52) U.S. Cl. CPC A01G 9/04

(57) ABSTRACT

A water catching and releasing saucer is described. The saucer may comprise a first bottom portion, a side portion in communication with the first bottom portion and having a passageway extending through it, and a side conduit in communication with the passageway that projects outward from the side portion. Additional features may include a drain trough within the first bottom portion extending to the passageway of the side portion, wherein the drain trough forms a second bottom portion that slopes downward at an acute angle to the side portion such that the height of the drain trough is disposed below the first bottom portion. An additional feature may include that the passageway of the side portion and side conduit are partially or completely disposed below the first bottom portion. Additionally, a complementary catch basin for capturing water from the saucer is described.

### CROSS-REFERENCE TO RELATED APPLICATIONS

The present application relies on the disclosure of and claims priority to and the benefit of the filing date of U.S. Provisional Application No. 62/078,494, filed Nov. 12, 2014, the disclosure of which is hereby incorporated by reference herein in its entirety.

### BACKGROUND OF THE INVENTION

1. Field of the Invention

The present invention relates to the field of gardening equipment. More particularly, the present invention relates to gardening saucers that catch and release water and complementary catch basins for capturing water released from such saucers.

2. Description of Related Art

Planter saucers are used in the gardening arts to support planters. Standing water in these saucers is a problem as it allows for growth of mosquito larvae and fungus. It is also known that after heavy rains or over-watering, the water-soaked soil may make these planters difficult to move. These issues make long term maintenance of large planters difficult for most people, and prevent those who are advancing in age or physically handicapped from even considering their use.

There have been attempts in the prior art to address these and related problems, including those described in U.S. Pat. Nos. 7,093,391; 6,047,499; 8,434, 261; 577,800; 5,042,197; U.S. 5,430,973; 5,819,469; and 7,114,288; and U.S. Published Patent Application Nos. 20050086863A1 and 20120255226. However, these designs are largely impractical. In some cases, the basin underneath the planter is too small, allowing water to leak all over. In other cases, the basin or pot has a plug on the bottom, which is difficult to get to when the pot is full of heavy, moist soil. Thus, there is a need in the art for improved planter saucers that overcome these limitations.

### SUMMARY OF THE INVENTION

Embodiments of the invention provide for a water catching and draining saucer, and optionally a complementary catch basin for capturing and holding water that is released from the saucer. The inventive saucer is designed to hold large planters while catching and conserving water from rain or sprinklers, while simultaneously allowing water to be released after it accumulates. The inventive saucer retains water when rain isn't in the forecast, allowing soil in the planters to reabsorb water in the saucer through holes in the bottom of the planter, yet allows water to be released during periods of heavy rain or overwatering so that standing water can be eliminated. Thus, the water catching and draining saucer helps keep a continuous supply of water to large plants, yet prevents growth of mosquito larvae and mold by providing a means to remove accumulated water after it has been sitting for a while. Additionally, embodiments of the inventive saucer allow heavy pots to be moved to other locations without lifting. These embodiments include the use of casters, wheels, or rollers to provide a means for rolling the saucer and heavy plant across support surfaces. Further, embodiments of the invention may provide a complementary catch basin for capturing water that is released from the saucer. This feature eliminates slippery surfaces and prevents damage or staining that would result from releasing the water on a deck or patio, and allows indoor use of the saucer. Thus, embodiments of the invention improve water management and transportation of planters used in gardening, thereby eliminating many of the problems identified above.

Embodiments of the invention provide a water catching and releasing saucer that may include a few, many, most, or substantially all of the following aspects and features in any combination. Additionally, the saucer may include any number of the features described herein. The saucer may comprise a first bottom portion, a side portion in communication with the first bottom portion and having a passageway extending through it, and a side conduit or drain in communication with the passageway that projects outward from the side portion. The side portion may be in communication with the bottom portion at an obtuse angle to allow the saucer to catch water even when holding large planters. Additional features may include a drain trough or gulley within the first bottom portion extending to the passageway of the side portion, wherein the drain trough forms a second bottom portion that slopes downward at an acute angle to the side portion such that the height of the drain trough is disposed below the first bottom portion. An additional feature may include that the passageway of the side portion and side conduit or drain are partially or completely disposed below the first bottom portion.

In embodiments, the drain trough or gulley may extend from the center of the first bottom portion to the passageway of the side portion. The drain trough may be nonpolygonal (i.e. curvilinear) shaped such as a semi-circular, semi-oval, or U-shaped, or be polygonal shaped such as triangular, V-shaped, rectangular, square, or trapezoidal, or may be a combination of curvilinear and polygonal shapes. In some embodiments, the bottom portion and side portion are nonpolygonal in shape (i.e. substantially curvilinear). In other embodiments, the bottom portion and side portion are polygonal in shape. Additionally, the height of the side portion and the diameter of the bottom portion may be at a ratio of approximately 0.16/1.

In other embodiments, the first bottom portion comprises an inner side and an outer side. The inner side of the first bottom portion may be concave or convex. Further, the inner side of the first bottom portion may have ribs or ridges projecting from it or may have no ribs or ridges projecting from it. Similarly, the outer side of the first bottom portion may have no ridges or ribs projecting from it or a plurality of ridges or ribs projecting from it. The plurality of ribs or ridges may extend radially or circularly or in a radial and circular combination along the outer side. The plurality of ribs and ridges serve to provide for reinforcement of the first bottom portion so that it can bear the weight of heavy planters without structural failure or strain on the other features.

Additional features may include a plurality of casters, wheels, or rollers extending from the outer side of the first bottom portion. In an exemplary embodiment, four casters are disposed along an outer edge of the outer side of the first bottom portion. Other features may include a valve within the side conduit, wherein the valve is configured with a first position and a second position, wherein the first position is configured to block passageway of water through the side conduit and the second position is configured to allow passageway of water through the side conduit. The valve may be any suitable type of valve used in the plumbing arts, non-limiting examples of which include a spigot or faucet valve, stopcock, ball valve, gate valve, sillcock valve, angle valve, and straight valve. Other features may include a cap covering an outer portion of the side conduit or a plug, wherein the cap or plug block an orifice of the side conduit.

Embodiments of the invention may also include a system. The system may include a saucer containing a few, many, most, or substantially all of the above described features and aspects in any combination. The system may also include a basin containing a few, many, most, or substantially all of the following features and aspects in any combination. The basin is provided to catch water released from the side conduit of the saucer. The basin may comprise a bottom portion, a side portion, and a top portion. The side portion may be in communication with the top portion and bottom portion, and the top portion may have a projecting portion on one side. Further, the top portion of the basin may be configured to form a through hole extending to an edge of the projecting portion. The through-hole of the basin may be sufficiently wide to catch a stream of water exiting the side conduit of the saucer. In some embodiments, the through-hole has slanted sides (like a funnel) to facilitate catching of water from the side conduit. Additionally, when the saucer and the basin are placed on a surface during use, the height of the side portion of the basin may be less than the height of the side conduit of the saucer. This allows the basin to be positioned so that the projecting portion and through hole may be placed underneath the side conduit of the saucer to catch water exiting the side conduit of the saucer. The top portion and bottom portion of the basin may be substantially curvilinear. Further, the side portion may be in communication with the bottom portion at an obtuse angle so that the dimensions of the top portion exceed those of the bottom portion. Such configuration provides for additional capability of the basin to catch water from the saucer. An additional feature may include a recess in the center of the top portion of the basin and a raised handle disposed in the recess. Additionally, the through hole may be disposed between the recess and the edge of the projecting portion.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1 is a schematic diagram showing a top perspective view of a water catching and draining saucer according to an embodiment of the invention.

FIG. 2 is a schematic diagram showing a front perspective view of a water catching and draining saucer according to an embodiment of the invention.

FIG. 3 is a schematic diagram showing a side perspective view of a water catching and draining saucer according to an embodiment of the invention.

FIG. 4 is a schematic diagram showing a bottom perspective view of a water catching and draining saucer according to an embodiment of the invention.

FIG. 5 is a schematic diagram showing a top perspective view of a complementary catch basin according to an embodiment of the invention.

FIG. 6 is a schematic diagram showing a front perspective view of a complementary catch basin according to an embodiment of the invention.

FIG. 7 is a schematic diagram showing a side perspective view of a complementary catch basin according to an embodiment of the invention.

FIG. 8 is a schematic diagram showing a top perspective view of a system comprising a water catching and draining saucer and a complementary catch basin according to an embodiment of the invention.

FIG. 9 is a schematic diagram showing a side perspective view of a system comprising a water catching and draining saucer and a complementary catch basin according to an embodiment of the invention.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

Included in embodiments of the invention is a water catching and releasing saucer, comprising: a saucer bottom with an inner surface; a drain trough in communication with the saucer bottom; a sidewall in communication with the saucer bottom and the drain trough and having a passageway through the sidewall; wherein the drain trough is disposed below and slopes downward at an acute angle from the inner surface of the saucer bottom to the passageway of the sidewall; a side conduit in communication with the passageway of the sidewall, extending from and projecting outwardly from the sidewall; wherein the side conduit is disposed partially or completely below the inner surface of the saucer bottom.

In embodiments, the saucer can have various features including for example one or more of: that the drain trough extends from the center of the saucer bottom to the side conduit, that the sidewall can be disposed at an obtuse angle from the inner surface of the saucer bottom, that the saucer bottom and/or the sidewall can be substantially curvilinear.

The saucer in particular embodiments can have a sidewall with a height measured from the inner surface of the saucer bottom to a sidewall rim and wherein the height of the sidewall and the diameter of the inner surface of the saucer bottom are at a ratio of between 1:5 to 1:20.

In embodiments, the saucer can be configured such that the inner surface of the saucer bottom is concave, and/or has no ribs or ridges projecting upwardly from the inner surface or any other upward projection. Alternatively, or in addition, the saucer can be configured such that the saucer bottom has an outer surface having a plurality of ribs or ridges extending downwardly from the outer surface, such as extending radially or annularly or both.

Saucers of this disclosure can further comprise a plurality of casters, wheels, or rollers in communication with the saucer, such as in communication with an outer surface of the saucer bottom. Preferably, the saucer comprises at least four casters, wheels, or rollers.

Embodiments of the saucer can comprise a valve in communication with the side conduit, wherein the valve is configured with a first position and a second position, wherein the first position is configured to dispose the valve in an open position to allow fluid to pass through the side conduit and the second position is configured to dispose the valve in a closed position to block fluid from passing through the side conduit. Also, in embodiments, a cap for the side conduit can be included.

In particular embodiments, a cross section of the drain trough reveals the drain trough is shaped as a semi-oval.

Still further embodiments of the water catching and releasing saucers of the invention can comprise: a saucer bottom with an inner surface and an outer surface; wherein the inner surface of the saucer bottom is concave and has no ribs or ridges projecting from the inner surface and the outer surface of the saucer bottom has a plurality of ribs or ridges projecting from the outer surface; a drain trough in communication with the saucer bottom; a sidewall in communication with the saucer bottom and the drain trough and having a passageway through the sidewall, wherein the sidewall is disposed at an obtuse angle from the inner surface of the saucer bottom; wherein the drain trough is disposed below and slopes downward at an acute angle from the inner surface of the saucer bottom to the passageway of the sidewall; a side conduit in communication with the passageway of the sidewall, extending from and projecting outwardly from the sidewall; wherein the side conduit is disposed partially or completely below the inner surface of the saucer bottom; a plurality of casters, wheels, or rollers in communication with the outer surface of the saucer bottom.

Saucer and basin systems are also included in embodiments of the invention, such as a system comprising: (i) a water catching and releasing saucer, comprising: a saucer bottom with an inner surface and an outer surface; a drain trough in communication with the saucer bottom; a sidewall in communication with the saucer bottom and the drain trough and having a passageway through the sidewall; wherein the drain trough is disposed below and slopes downward at an acute angle from the inner surface of the saucer bottom to the passageway of the sidewall; a side conduit in communication with the passageway of the sidewall, extending from and projecting outwardly from the sidewall; wherein the side conduit is disposed partially or completely below the inner surface of the saucer bottom; a plurality of casters, wheels, or rollers in communication with the outer surface of the saucer bottom which suspend an outer surface of the drain trough at a height above a surface on which the saucer is placed during use; and (ii) a basin with a top having a through-hole opening and with a height of less than the height the outer surface of the drain trough is suspended during use.

For example, embodiments can comprise a basin shaped with a projecting portion on one side, such that during use the projecting portion and the through-hole opening of the basin are capable of being positioned below the bottom surface of the drain trough and the side conduit. In embodiments, the projecting portion is shaped to allow it to be inserted under the side conduit in order to catch fluid being released from the saucer through the side conduit into the basin. The through-hole may be configured to catch water exiting the side conduit of the saucer, such as having a sufficient dimension or sloped sides to catch and funnel water into the interior of the basin.

In embodiments, the basin can have one or more of the following features: that the outline of the basin is curvilinear, that the basin top comprises a recessed handle, and/or that the through-hole opening is disposed between the recessed handle and an edge of the projecting portion of the basin.

In embodiments, the water catching and draining saucer may comprise a shape with a bottom portion and one or more sidewalls and an open top. The shape may be nonpolygonal such as curvilinear (e.g. circular, oval, or cylindrical shape) or a polygonal such as a square or rectangular shape, or some combination of these. The side portions may be configured at right angles to the bottom portion or slope at an obtuse angle from the bottom portion to facilitate the capture of water. In the latter embodiment, the saucer appears as an inverted trapezoid in its side cross section.

In one embodiment, the saucer has a concave bottom portion to facilitate drainage. A drain trough or gulley may extend from the central portion of the concave bottom to a passageway in the side wall that leads to a side conduit. The drain trough may have a bottom that gradually slopes downward at an acute angle from the concave bottom of the saucer such that the drain trough extends to a side conduit underneath the concave bottom.

In embodiments, the drain trough or gulley may be nonpolygonal (i.e. curvilinear) shaped such as semi-circular, semi-oval, or U-shaped, or be polygonal shaped such as triangular, V-shaped, rectangular, square, or trapezoidal, or may be a combination of curvilinear and polygonal shapes. Additionally, in other embodiments, multiple drain troughs (i.e. two, three, or more) may extend from the inner concave bottom to a single side conduit. For example, two drain troughs may extend from either side of the central portion to the side conduit and one drain trough may extend from the central portion, and the three drain troughs may converge at a single side conduit. In another example, two drain troughs may extend from the central portion to two side conduits positioned at opposite sides of the saucer. Further, in other embodiments, the inner bottom portion of the saucer may be slightly convex to allow water to accumulate at a drain trough that extends along the sides of the saucer. Alternatively, multiple drain troughs may extend radially from the center of the convex bottom. In other embodiments, the inner bottom portion may slope up from one side of the saucer and multiple drain troughs may extend from the elevated side and converge to a side conduit on the depressed side. Alternatively, the inner bottom portion of the saucer may slope upward from two opposite sides to meet at an elevated ridge extending along the diameter bisecting the saucer, and two opposite side conduits may be positioned on opposite sides of the ridge. In embodiments, the inner bottom portion may have ridges, ribs, or otherwise raised portions of the bottom of the saucer. These may be used to channel water to the one or more side conduits or provide additional separation of adjacent drain troughs. However, in other embodiments, the drain troughs of the saucer slope downward from the saucer bottom so that the height of the drain trough is disposed below the inner bottom portion of the saucer and the side conduit is positioned underneath the bottom portion of the saucer as well. In these and other embodiments, the inner bottom portion (whether convex or concave) has no ridges, ribs, or otherwise raised portions. These configurations are merely examples, and a skilled artisan can identify variations of them that are within the context of this disclosure.

The side conduit(s) may extend outward from the side portion of the saucer and may have a removable cap or plug that allows water to be held in place by covering an orifice on the conduit. The cap may be a threaded cap or may fit through a friction fit. The cap may be made of a hard plastic material and the plug may be made of rubber. Alternatively, the side conduit may end in a valve that may be turned to hold or release water. The valve may have a configuration that allows water to pass and a configuration that releases water. The valve may be configured as a faucet and controlled with a knob, handle, or the like. Additionally, combinations with both a valve and cap or plug are possible.

In embodiments, the saucer has multiple casters, wheels, or rollers extending from the bottom to allow movement of the saucer when it is carrying heavy planters. The saucer may have anywhere from 3 to 8 casters, wheels, or rollers. In an exemplary embodiment, the saucer has four casters, wheels, or rollers. The casters, wheels, or rollers may be positioned along the outer edge of the saucer, or may be positioned at interior locations. In one embodiment, the casters, wheels, or rollers are positioned at equal intervals to facilitate unbiased movement of the saucer. The casters, wheels, or rollers may be manufactured from a hard polymeric material or metal and may be attached to the bottom of the saucer with a metallic neck or mounting bar. In other embodiments, the casters, wheels, or rollers are attached to a separate complementary platform that interlocks with the saucer. The saucer and platform may interlock through latches or projections and recesses disposed on the saucer and platform. Projections on the saucer configured to interlock with recesses in the platform may additionally serve as support structures or legs for the saucer. The additional platform with casters, wheels, or rollers may thus provide an option for both mobile and stationary use of the saucer. Additionally, the bottom of the saucer may have one or more support ridges or ribs extending in a radial and/or circular pattern. Support ridges and ribs allow the saucer to maintain its shape and structural integrity when supporting heavy pots and planters without putting strain on other features such as casters or mounting bars.

In an exemplary embodiment, the water catching and draining saucer has a substantially circular bottom and a side portion sloping upward at an obtuse angle from the circumference of the bottom portion. The inventive saucer may be provided in a variety of dimensions. The water catching and draining saucer may have a configuration defined by the following portions relative to the outer bottom diameter expressed as percentages. However, it should be stressed that these percentages are merely exemplary and that other configurations are possible. For convenience, the percentages are defined relative to the diameter of the outer bottom portion of the saucer. As used herein, the terms “approximate”, “approximately”, or “about” when referring to a value mean that the value may be anywhere from 25% below to 25% above that value. Thus, “approximately 16 inches” in length means that the value may be anywhere from 12 to 20 inches in length. The following table provides exemplary dimensions of the saucer relative to the Outer Bottom Diameter.

| | Approximate Percentage |
|---|---|
| Feature | of Outer Bottom Diameter |
| Height of Side Portion | 5% to 25% |
| Height of Caster (including neck) | 5% to 25% |
| Depth of Drain Trough (at its deepest) | 2.5% to 7.5% |
| Width of Drain Trough (at its widest) | 5% to 20% |
| Outer Diameter of Side Conduit | 2.5% to 7.5% |
| Height of Reinforcement Ribs | 1.5% to 4.5% |
| Spacing Between Casters | 30% to 90% |
| Inner Bottom Diameter | 75% to 100% |
| Top Diameter (from top of Side Portion) | 100% to 125% |

In exemplary embodiments, the saucer may have the following absolute dimensions. The outer bottom diameter may be about 16 inches. The height of the side portion may be about 2.5 inches. The height of the caster (including neck or mounting bar) may be about 2.5 inches. The depth of the drain trough may be about 0.75 inches at its deepest point. The width of the drain trough at its widest point may be about 2 inches. The outer diameter of the side conduit may be about 0.75 inches. The height of the reinforcement ribs may be about 0.50 inches. The spacing between casters may be about 9.75 inches. The inner bottom diameter may be about 15.5 inches. The top diameter (from top of side portion) may be about 17.50 inches. The distance from the side drain to the outermost side is about 8.75 inches. The distance of each caster to a center line on the saucer is about 4.87 inches. However, it should be stressed that these dimensions are merely exemplary.

Embodiments of the invention also provide for a complementary catch basin that catches water from the saucer when it is released. The complementary catch basin may have a shape that is similar to the saucer and may also be injection molded. In other embodiments, the complementary catch basin is shaped differently than the saucer. The basin may be any nonpolygonal or polygonal shape. In an exemplary embodiment, the complementary catch basin is curvilinear-shaped with a curved protrusion, bulge, or projection on one side. The complementary catch basin may have a bottom portion, side portions, and a top portion covering a majority of the basin. The top portion may have a handle raised in an indentation or recess in the center of the top portion. Additionally, the top portion may have a drain or pour opening disposed within it extending from the central indentation to the leading edge of the protrusion or bulge. The drain or pour opening is preferably circular or oval in shape. During use, the basin is positioned so that the opening is positioned underneath the side conduit to catch water released from the saucer. Thus, only the projecting portion of the basin may be disposed under the saucer during use. The complementary catch basin may be stored in a cabinet or on a shelf until the saucer is ready to be drained. The catch basin allows the saucer to be drained in place, and by capturing water from the basin obviates the need to release water under decks or patios which may produce slick surfaces or damage or stain surfaces, and allows for indoor use. Additionally, both the sides of the saucer and the sides of the complementary basin may have a fill line or other indicator indicating when they have reached capacity and it's time to drain them. The capacity of the catch basin may be equal to or greater than the capacity of the saucer.

The water catch basin may have a configuration defined by the following percentages relative to the diameter of the bottom of the catch basin. However, it should be stressed that these ratios are merely exemplary and that other configurations are possible. The percentage of the diameter of the recess relative to the diameter of the bottom of the catch basin may be about 20% to about 40%. The percentage of the width or length of the opening relative to the diameter of the bottom of the catch basin may be about 20% to about 40%. The percentage of the height of the catch basin relative to the diameter of the bottom of the catch basin may be about 5% to about 20%. The percentage of the width of the recessed handle relative to the diameter of the recess may be about 10% to about 20%. The percentage of the bottom diameter relative to the top diameter may be about 75%.

In exemplary embodiments, the catch basin may have the following absolute dimensions. The bottom of the catch basin may be about 15.25 inches in diameter. The top of the catch basin may be about 16.25 inches in diameter. The diameter of the recess may be about 5 inches. The width of the recessed handle may be about 0.75 inches. The dimensions of the opening may be about 5.5 inches in length by about 4.25 inches wide. The height of the side portion may be about 1.5 inches.

The saucer and catch basin of the invention may be injection molded to form a single layer of polymeric material of unitary construction that may form various features including bottom, side walls, support ridges, and conduit. In embodiments, the single layer of material may be about 0.25 inches in width. In other embodiments, the single layer may be about 0.10 to 0.50 inches in width. In other embodiments, the inventive saucer and catch basin is formed of multiple layers of polymeric material, or instead of unitary construction may be assembled from subcomponents that form the various features. In other embodiments, the saucer and catch basin may be made of glass, ceramic material, earthen material, or a metallic alloy. The saucer and catch basin may be manufactured in a variety of shapes and colors to match the aesthetic requirements of the user.

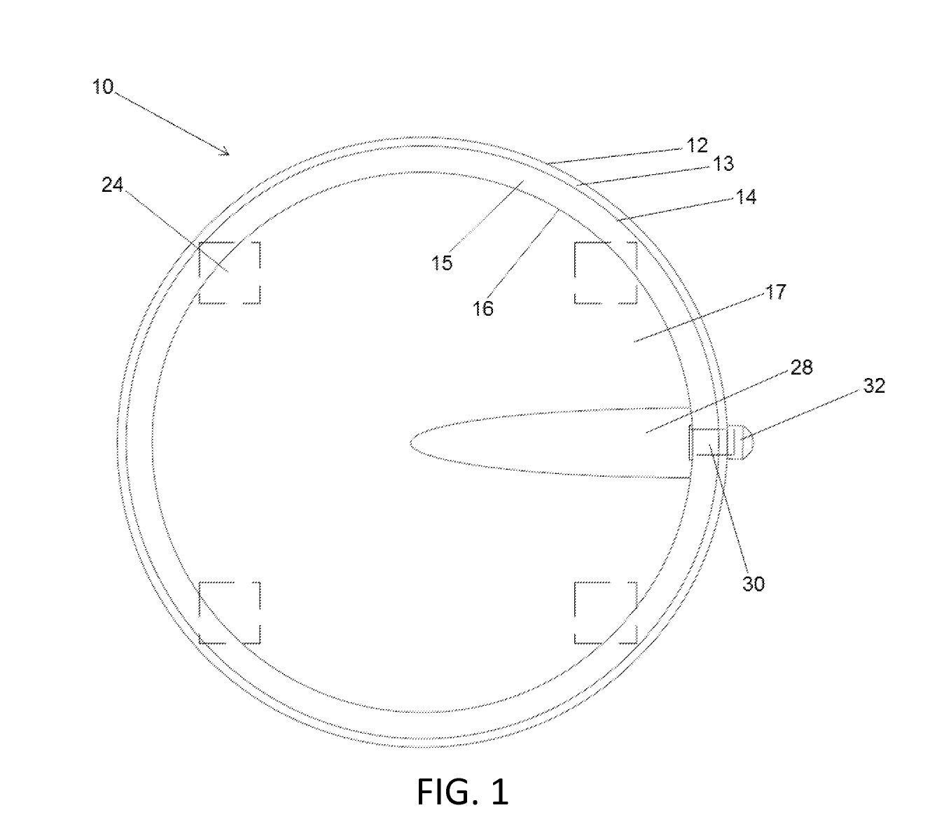

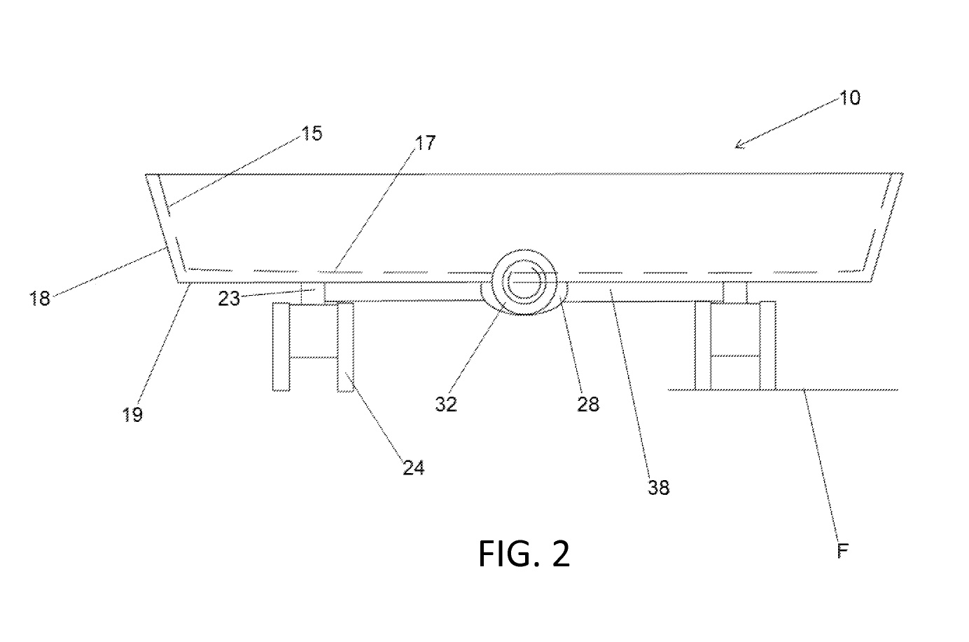

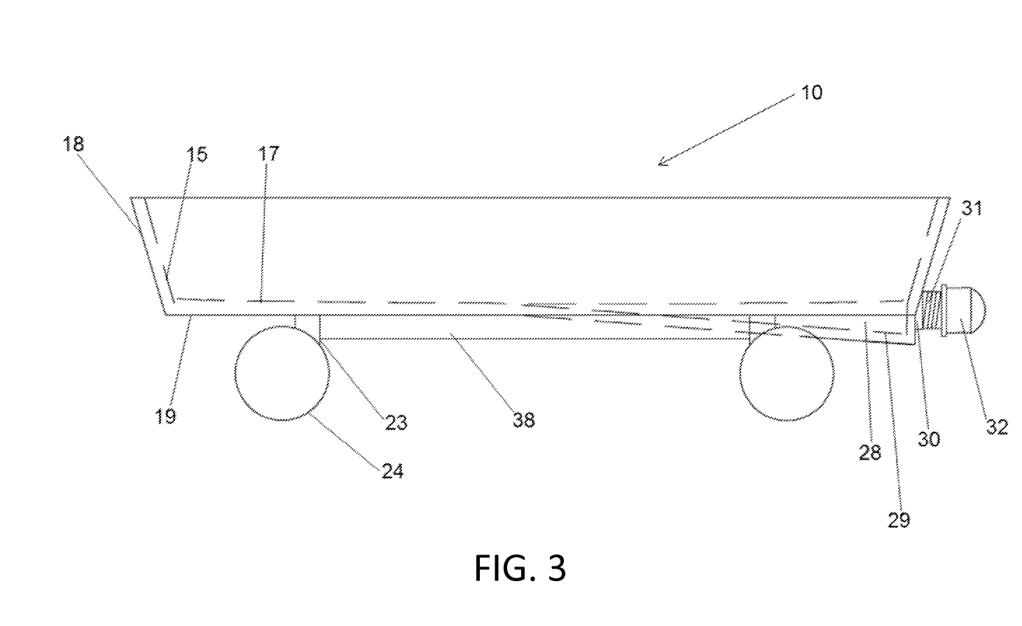

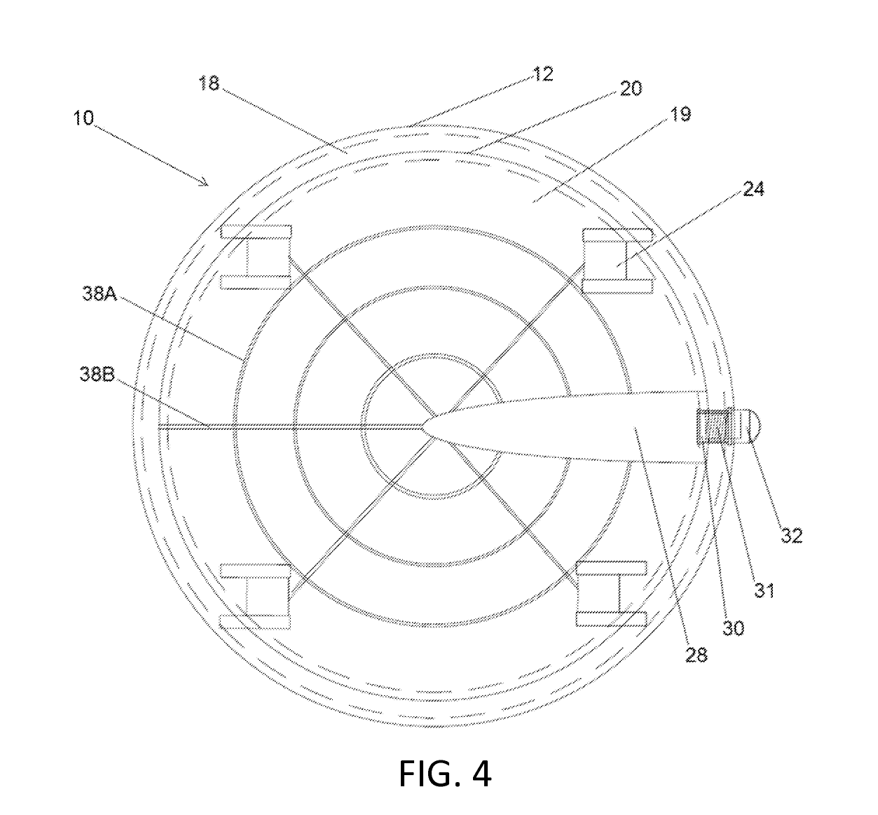

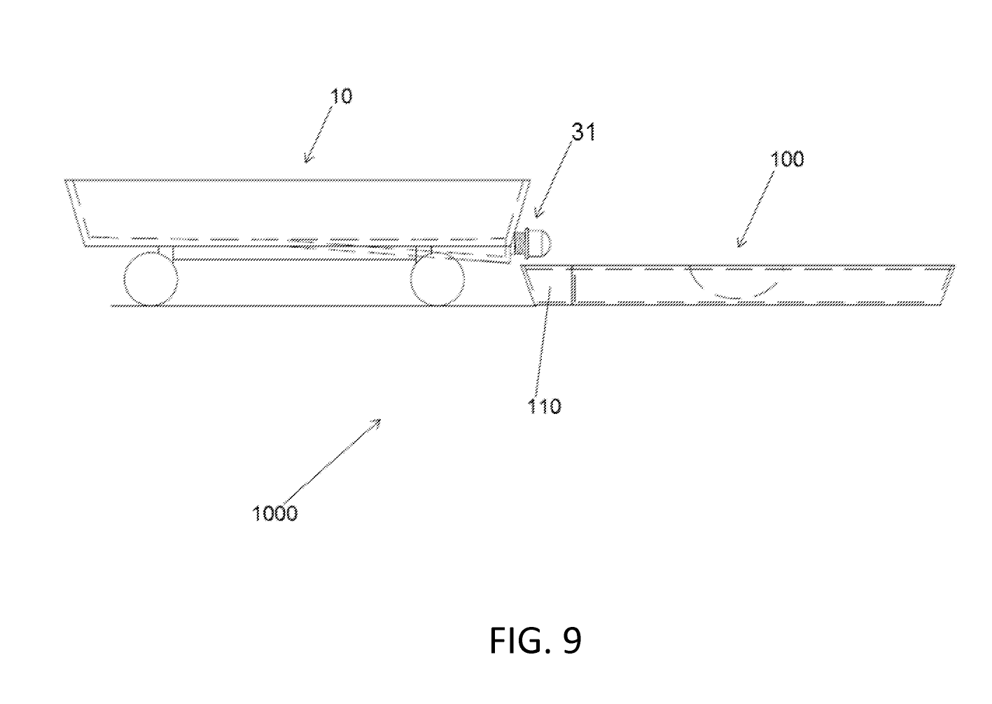

Turning now to the Figures, FIGS. 1-4 show an embodiment of the water catching and draining saucer 10 of the invention, with FIG. 1 showing a top perspective view, FIG. 2 showing a front perspective view, FIG. 3 showing a side perspective view, and FIG. 4 showing a bottom perspective view. In the context of this disclosure, terms describing orientation, such as inner, outer, upper, lower, bottom, and top, are used for purposes of convenience and refer to the orientation of the saucer, basin, and system as shown for example in FIG. 9.

The embodiment shown in FIGS. 1-4 is intended to be illustrative of certain features that the invention may possess rather than limiting. The inventive saucer may have a few, some, many, most, or substantially all of the following features, and may include alternatives as appreciated by skilled artisan. Saucer 10 is made of a thin layer 13 of polymeric material, shaped to define a circular inner bottom portion 17 (otherwise referred to as the inner surface of the saucer) surrounded by an inner side portion 15 sloping at an obtuse angle from inner bottom portion 17. Top of side portion 15 shows thin layer 13 of polymeric material with outer edge 12 and inner edge 14. Saucer 10 further includes outer bottom portion 19 (outer surface of the saucer) and outer side portion 18, as seen in FIG. 2. Inner side portion 15, outer side portion 18, outer edge 12, inner edge 14, and thin layer 13 together comprise the sidewall of the saucer, and where edges 12 and 14 together comprise the sidewall rim.

Circumference 16 of inner bottom portion 17 is substantially circular. Further, inner bottom portion 17 (inner surface of saucer) is slightly concave in shape to facilitate drainage. Extending from the inner surface of the saucer (for example, from center of inner bottom portion 17 to inner side portion 15) is drain trough 28, and extending from drain trough 28 is passageway 30 through both inner 15 and outer 18 side portions of the sidewall. The passageway 30 is configured to allow water to escape from the inner portion of saucer 10. FIG. 3 shows that bottom 29 of drain trough 28 slopes downward from inner bottom portion 17 at an acute angle such that the drain trough 28 gradually increases in height until it reaches the sidewall and passageway 30 extending through inner 15 and outer 18 side portions. Passageway 30 is in communication with side conduit 31 projecting from outer side portion 18. The outer portion of side conduit 31 is threaded for attaching cap 32 covering orifice in conduit for releasing water (not shown).

Four casters 24 are attached to outer bottom portion 19 through neck 23. In particular, FIG. 2 shows casters 24 relative to floor line F, and the height above floor line F (a surface on which the saucer is disposed) at which the outer (bottom) surface of the saucer and the outer (bottom) surface of the drain trough are disposed or suspended above the support surface, such as the floor. FIGS. 2 and 3 show that outer bottom portion 19 has support ridges or ribs 38 extending from it. FIG. 4 shows that support ribs may extend in concentric circular pattern 38A as well as radial pattern 38B extending to circumference 20 of outer bottom portion 19.

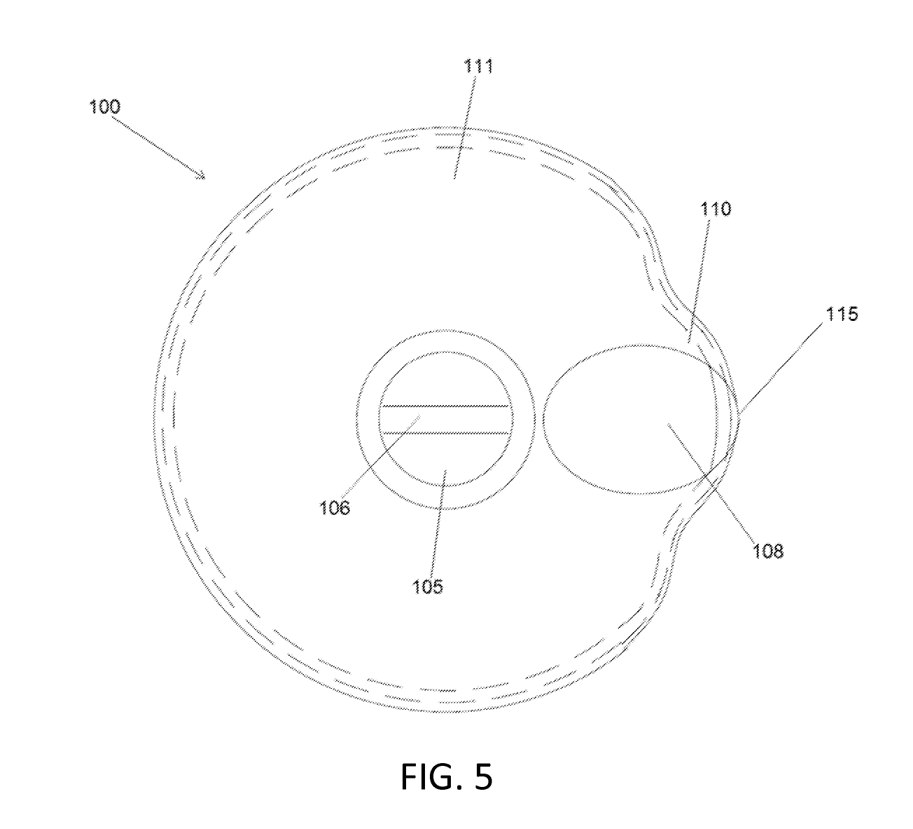

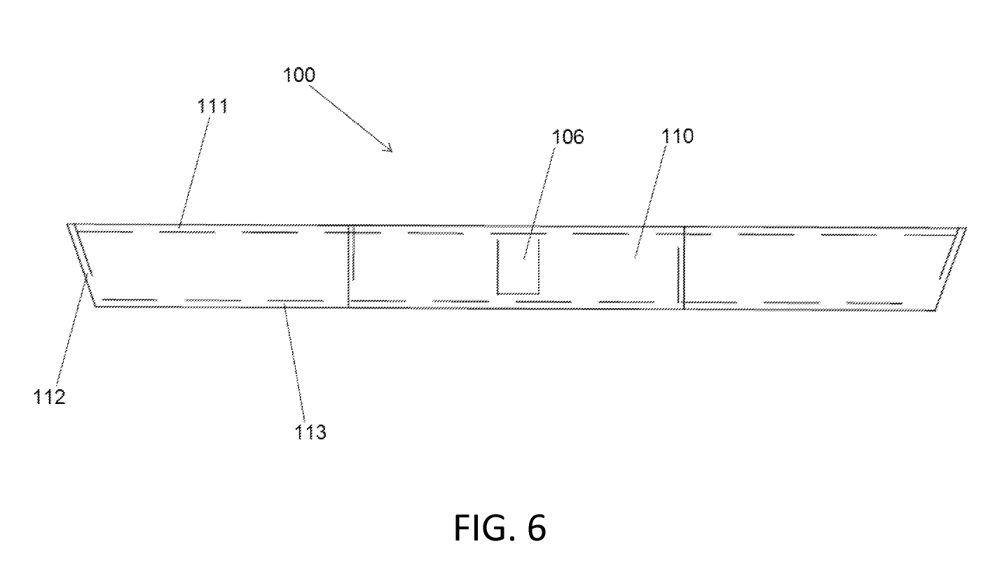

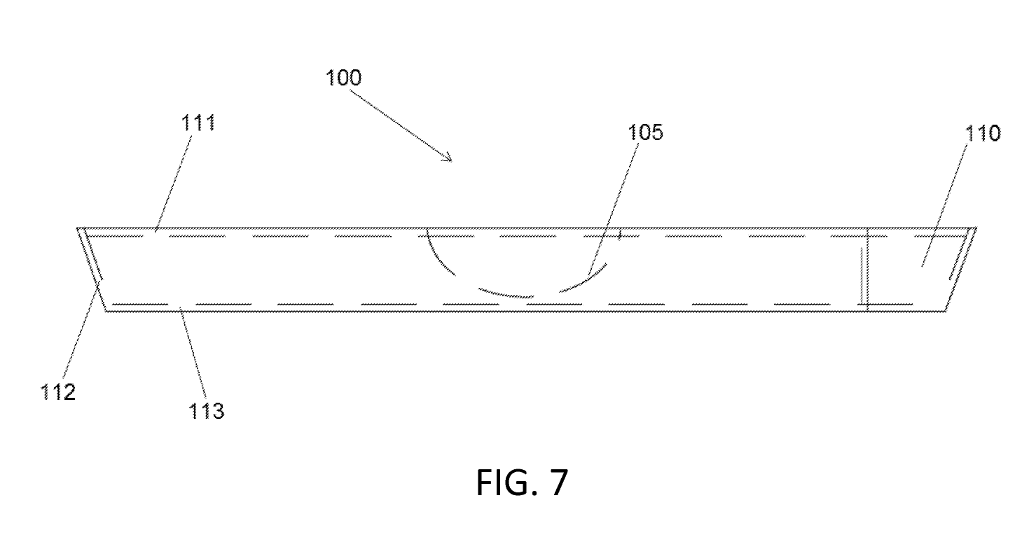

FIGS. 5-7 show an embodiment of a complementary catch basin 100 for catching water when it is released from the saucer. Again, these figures are intended to show an illustrative embodiment rather than be limiting. Basin 100 is curvilinear-shaped but has projecting portion 110 on the side and recess 105 in the center with handle 106 disposed across recess 105. Drain/pour opening 108 disposed in top portion 111 extends from center recess 105 to leading edge 115 of projecting portion 110. FIGS. 6 and 7 show that side portion 112 extends from bottom portion 113 at an obtuse angle.

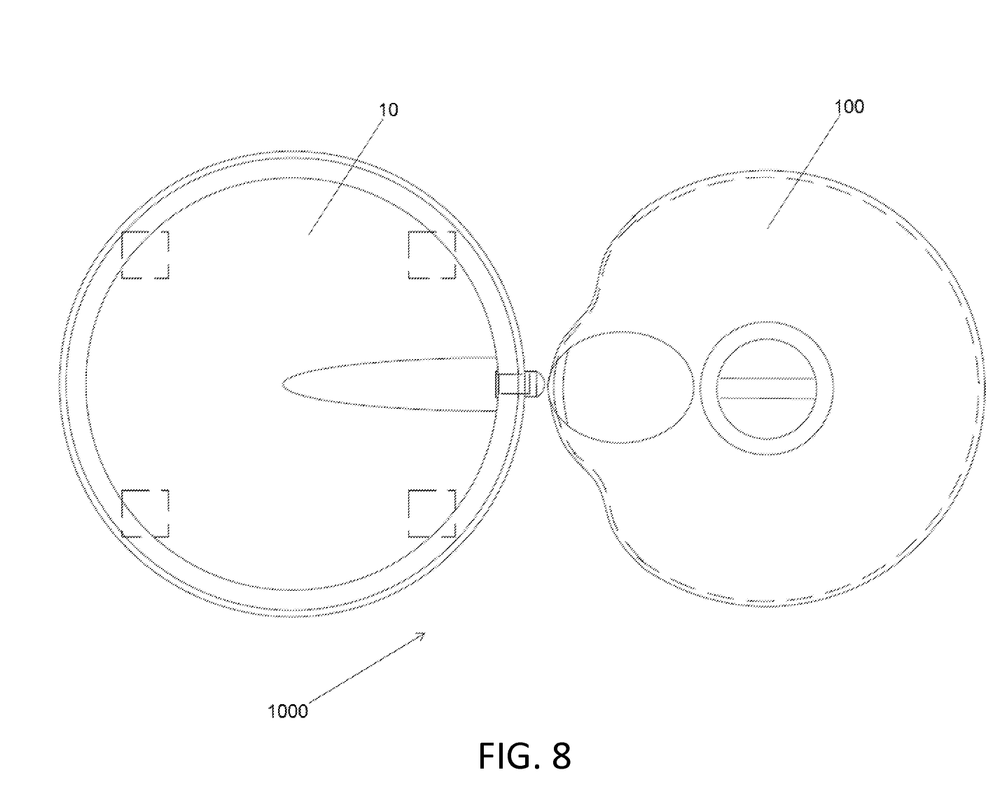

FIGS. 8 and 9 show a system 1000 comprising a water catching and draining saucer 10 and a complementary catch basin 100 according to an embodiment of the invention. In particular, FIG. 9 shows that during use, the projecting portion 110 of the catch basin 100 is positioned underneath the side conduit 31 of the saucer 10 so that the drain/pour opening may catch water released from the saucer. As is also shown in FIG. 9, in embodiments, the basin 100 can have a height measured from its bottom surface to its top surface that is less than the height that the bottom surface of the saucer or the bottom surface of the drain trough is disposed above the floor. This configuration allows for the projecting portion of the basin to slide freely under the side conduit of the saucer to position the through-hole opening in the top of the basin under the side conduit to catch and contain fluid released from the saucer through the side conduit.

To use the invention, a garden planter or pot filled with soil supporting a plant is placed within the saucer. The saucer with planter may be placed outdoors on a support surface (e.g. patio, porch, deck) to capture rain or water from sprinklers, or alternatively may be placed indoors on a floor or carpet. The saucer and planter may be rolled horizontally by virtue of the casters, wheels, or rollers. Preferably, the diameter of the saucer is somewhat larger than the diameter of the planter so that the sloping sides of the saucer can capture additional water. The user monitors the saucer for accumulation of water. When the water level reaches the fill line or other indicator, the user then removes the complementary catch basin from storage and places it so that the projecting portion is positioned underneath the side conduit. The user then turns the valve or removes the cap or plug to allow water to escape from the side conduit. Water captured from the catch basin then may be disposed of at a suitable location (e.g. sink, lawn) through the drain/pour opening. The catch basin may then be stored again until future use.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A water catching and releasing saucer, comprising:
a saucer bottom with an inner surface;
a drain trough in communication with the saucer bottom;
a sidewall in communication with the saucer bottom and the drain trough and having a passageway through the sidewall;
wherein the drain trough is disposed below and slopes downward at an acute angle from the inner surface of the saucer bottom to the passageway of the sidewall;
a side conduit in communication with the passageway of the sidewall, extending from and projecting outwardly from the sidewall;
wherein the side conduit is disposed partially or completely below the inner surface of the saucer bottom.

2. The saucer of claim 1, wherein the drain trough extends from the center of the saucer bottom to the side conduit.

3. The saucer of claim 1, wherein the sidewall is disposed at an obtuse angle from the inner surface of the saucer bottom.

4. The saucer of claim 1, wherein the saucer bottom and the sidewall are substantially curvilinear.

5. The saucer of claim 4, wherein the sidewall has a height measured from the inner surface of the saucer bottom to a sidewall rim and wherein the inner surface of the saucer bottom has a diameter, such that the height of the sidewall and the diameter of the inner surface of the saucer bottom are at a ratio of between 1:5 to 1:20.

6. The saucer of claim 1, wherein the inner surface of the saucer bottom is concave.

7. The saucer of claim 6, wherein the inner surface of the saucer bottom has no ribs or ridges projecting upwardly from the inner surface.

8. The saucer of claim 6, wherein the saucer bottom has an outer surface having a plurality of ribs or ridges extending downwardly from the outer surface.

9. The saucer of claim 8, wherein the plurality of ribs or ridges extend radially or annularly or both.

10. The saucer of claim 1, further comprising a plurality of casters, wheels, or rollers in communication with an outer surface of the saucer bottom.

11. The saucer of claim 10 comprising four casters, wheels, or rollers.

12. The saucer of claim 1, further comprising a valve in communication with the side conduit, wherein the valve is configured with a first position and a second position, wherein the first position is configured to dispose the valve in an open position to allow fluid to pass through the side conduit and the second position is configured to dispose the valve in a closed position to block fluid from passing through the side conduit.

13. The saucer of claim 1, further comprising a cap for the side conduit.

14. The saucer of claim 1, wherein a cross section of the drain trough reveals the drain trough is shaped as a semi-oval.

15. A water catching and releasing saucer, comprising:
a saucer bottom with an inner surface and an outer surface;
wherein the inner surface of the saucer bottom is concave and has no ribs or ridges projecting from the inner surface and the outer surface of the saucer bottom has a plurality of ribs or ridges projecting from the outer surface;
a drain trough in communication with the saucer bottom;
a sidewall in communication with the saucer bottom and the drain trough and having a passageway through the sidewall, wherein the sidewall is disposed at an obtuse angle from the inner surface of the saucer bottom;
wherein the drain trough is disposed below and slopes downward at an acute angle from the inner surface of the saucer bottom to the passageway of the sidewall;
a side conduit in communication with the passageway of the sidewall, extending from and projecting outwardly from the sidewall;
wherein the side conduit is disposed partially or completely below the inner surface of the saucer bottom;
a plurality of casters, wheels, or rollers in communication with the outer surface of the saucer bottom.

16. A system comprising:
(i) a water catching and releasing saucer, comprising:
a saucer bottom with an inner surface and an outer surface;
a drain trough in communication with the saucer bottom;
a sidewall in communication with the saucer bottom and the drain trough and having a passageway through the sidewall;
wherein the drain trough is disposed below and slopes downward at an acute angle from the inner surface of the saucer bottom to the passageway of the sidewall;
a side conduit in communication with the passageway of the sidewall, extending from and projecting outwardly from the sidewall;
wherein the side conduit is disposed partially or completely below the inner surface of the saucer bottom;
a plurality of casters, wheels, or rollers in communication with the outer surface of the saucer bottom which suspend an outer surface of the drain trough at a height above a surface on which the saucer is placed during use; and
(ii) a basin with a top having a through-hole opening and with a height of less than the height the outer surface of the drain trough is suspended during use.

17. The system of claim 16, wherein the basin is shaped with a projecting portion on one side, such that during use the projecting portion and the through-hole opening of the basin are capable of being positioned below the bottom surface of the drain trough.

18. The system of claim 16, wherein an outline of the basin is curvilinear.

19. The system of claim 16, wherein the basin top comprises a recessed handle.

20. The system of claim 19, wherein the through-hole opening is disposed between the recessed handle and an edge of the projecting portion of the basin.
